(19) United States
(12) Patent Application Publication
(10) Pub. No.: US 2020/0032983 A1
(43) Pub. Date: Jan. 30, 2020

(54) FRAME BASED LUMINAIRE AND MODULAR CEILING COMPRISING THE SAME

(71) Applicant: SIGNIFY HOLDING B.V., EINDHOVEN (NL)

(72) Inventors: MIN CHEN, SHANGHAI (CN); QIN LI, EINDHOVEN (NL); ZHEN YI ZHENG, EINDHOVEN (NL); LEI SUI, SHANGHAI (CN); QUN LUO, SHANGHAI (CN)

(21) Appl. No.: 16/488,892

(22) PCT Filed: Mar. 1, 2018
(86) PCT No.: PCT/EP2018/055022

§ 371 Date: Aug. 26, 2019

(30) Foreign Application Priority Data
Mar. 9, 2017 (CN) PCT/CN2017/076194
Apr. 20, 2017 (EP) 17167239.7

(51) Int. Cl. F21V 7/18; F21S 8/02; F21V 17/00; F21V 15/01

(52) U.S. Cl. CPC F21V 7/18; F21V 15/012; F21V 17/007; F21S 8/026

(57) ABSTRACT

A luminaire (100) comprises an elongate support member (101) which carries at least one light source (102). The elongate support member extends lengthways between opposing end portions. Spacer elements (103) respectively extend from the opposing end portions and support a reflector canopy (104) which extends over the elongate support member. The at least one light source faces the reflector canopy. The reflector canopy is foldable in a direction normal to the lengthways extension of the elongate support member and/or is foldable in the lengthways direction together with the support member. Further provided is a modular ceiling comprising at least one said luminaire.

### FIELD OF THE INVENTION

This invention relates to a frame based luminaire. The invention further relates to a modular ceiling comprising at least one said luminaire.

### BACKGROUND OF THE INVENTION

An indirect luminaire comprises a light source which emits light towards a reflective surface. The reflective surface redirects the light towards a space to be illuminated.

Such luminaries have typically been designed to accommodate standard fluorescent lamps, but are now often designed with integral LED sources.

The redirected light may be more diffuse than that originally emanating from the light source(s). The redirection of the light by the reflective surface may assist in reducing glare experienced by persons occupying the illuminated space in comparison to, for instance, direct (e.g. ‘up-down’) luminaires, in which light emanates directly from the light source into the space being illuminated.

The inner parts and surfaces of direct luminaires which are exposed to the light source may also comprise reflective coatings which may increase the amount of light exiting the luminaire, thus increasing the luminous efficiency. However, owing to the issue of glare, direct luminaires tend to require extra components, such as diffusers, which may assist to render the light emanating from them more diffuse. Indirect luminaires may not require such extra components (e.g. diffusers), thus offering potential for lower cost designs comprising fewer materials. The anti-glare properties of indirect luminaires make them suitable for lighting continuously used areas, such as offices. Accordingly, use of indirect luminaires may assist to alleviate eyestrain for users of such areas.

Indirect luminaires typically hang as pendant luminaires from a ceiling or may be employed as troffers. Troffers tend to be recessed into a plenum area above a suspended ceiling. A suspended ceiling typically comprises a grid made up of square or rectangular cells. The cells tend to have standardized area dimensions of either 2 feet by 2 feet, or 2 feet by 4 feet, although other sizes are also possible. A troffer intended for a suspended ceiling must be dimensioned such that it fits into such a cell.

The components of indirect luminaires, e.g. troffers, are conventionally mounted and contained within a housing. The housing is typically made of a metal or metal alloy, such as aluminium or steel, and the inside of the housing may be painted with a reflective coating. The housing may represent a significant contributor to the size and weight of the indirect luminaire. Accordingly, the storage and transportation of such luminaires are liable to be difficult and costly. For example, more packaging is required for shipping of larger sized luminaires which contributes to the overall cost of the luminaires including their cost of transportation.

One strategy is to replace metal housings with plastic housings. This may reduce the weight of the luminaire owing to plastics tending to be less dense than metals.

The inner surfaces of metal housings may, in principle, be rendered reflective by subjecting them to various processes, such as polishing. However, in practice, the inner surfaces of metal housings tend to be painted with a suitable reflective coating. In contrast, providing reflective inner surfaces for plastic housings may be more straightforward and thus painting may not be required. Accordingly, a plastic housing may also obviate the requirement to paint its inner surfaces such that the weight of the housing may be further decreased (and the cost of painting may be saved).

However, the size of housing may be problematic in terms of the amount of plastic required, and the associated cost. Furthermore, whilst plastic housings may result in a lighter luminaire/, the size of the housing may nonetheless mean that the luminaire, and in particular a plurality of such luminaires, may prove to be difficult to store or transport efficiently. High packaging costs for such a luminaire also remain a problem.

There is thus a need for an indirect luminaire design which may be more easily and efficiently transported or stored.

### SUMMARY OF THE INVENTION

The present invention seeks to provide a luminaire for providing indirect lighting which may be transported or stored with greater ease and efficiency than conventional indirect luminaires.

The invention is defined by the claims.

In accordance with an aspect, there is provided a luminaire comprising an elongate support member extending in an elongation direction between opposing end portions, and carrying at least one light source; a pair of spacer elements extending from the opposing end portions; and a reflector canopy extending over the support member and being at least partially supported by the pair of spacer elements, wherein: the reflector canopy is foldable in a direction normal to the elongation direction; and/or the reflector canopy is foldable in the elongation direction together with the support member; the at least one light source facing the reflector canopy when the luminaire is in an unfolded status.

The luminaire comprises an elongate support member carrying at least one light source which faces a foldable reflector canopy so as to provide an indirect lighting effect. The foldable nature of the reflector canopy may be such that a degree to which the reflector canopy extends in directions normal to the elongation direction may be smaller for the folded shape with respect to the unfolded shape. Alternatively or additionally, the reflector canopy may be folded in the elongation direction of the elongate support member, together with the elongate support member itself, such that an extension of the luminaire in the elongation direction (as defined in respect of the unfolded luminaire) may be smaller with respect to that of the unfolded shape. Thus the folded shape of the luminaire may comprise a smaller form factor than the unfolded shape resulting in greater ease and efficiency of storage or transportation of the folded luminaire, thereby reducing its packaging and transportation costs. In addition, as the structure of the luminaire may furthermore obviate the need for a housing, the luminaire may be lighter than, for instance, an indirect luminaire comprising a housing, which further reduces its manufacturing cost.

The reflector canopy may comprise a pair of support ribs extending normally to the elongation direction, each of the support ribs engaging with one of the spacer elements. In this way the support ribs may assist to support the reflector canopy. Each of the support ribs may comprise a plurality of flexibly coupled members for facilitating folding of the reflector canopy in the direction normal to the elongation direction. The flexibly coupled members may at least partially support elongate portions of the reflector canopy extending between the support ribs. Folding of the flexibly coupled members may result in folding of the reflector canopy in a direction normal to the elongation direction.

Neighbouring couplings of the plurality of flexibly coupled members may be configured to pivot in opposite directions relative to each other such that the flexibly coupled members are stacked upon folding of the reflector canopy in the direction normal to the elongation direction. Correspondingly, the elongate portions of the reflector canopy may be stacked upon stacking of the flexibly coupled members such that the reflector canopy may be folded in a particularly spatially efficient manner.

The reflector canopy may comprise a pair of further support ribs, each further support rib extending between the pair of support ribs along an edge of the reflector canopy parallel to the elongation direction so as to provide additional support to the reflector canopy.

The luminaire may additionally comprise at least one pair of opposing support limbs, each of the support limbs extending from a first connection point located at a corner or an edge of the reflector canopy parallel to the elongation direction to a second connection point with the elongate support member. The opposing support limbs may provide additional support to the reflector canopy. The first and second connection points may comprise pivot points when the reflector canopy is foldable in the direction normal to the elongation direction in order to facilitate folding of the reflector canopy in a direction normal to the elongation direction.

The elongate support member may comprise a plurality of flexibly coupled segments to facilitate folding in the elongation direction. Neighbouring further couplings of the plurality of flexibly coupled segments may be configured to pivot in opposite directions relative to each other such that the segments are stacked upon folding in the elongation direction. Such stacking of the flexibly coupled segments may result in a particularly spatially efficient folding of the elongate support member in the elongation direction.

The reflector canopy may comprise a pliable material. Such a pliable material may be folded in a direction normal to the elongation direction. Alternatively or additionally, the pliable material may permit folding in the elongation direction, together with folding of the elongate support member. The reflector canopy may comprise at least one selected from a polymer film, a paper sheet, and a textile sheet. A reflector comprising such materials may, for instance, be light-weight and pliable thereby contributing to the ease and efficiency with which the luminaire may be transported and stored.

The reflector canopy may comprise an arcuate shape and may arch over the elongate support member in the normal direction. An arcuate shape may improve the luminous efficiency of the reflector canopy by permitting it to collect and redirect a greater angular proportion of the luminous distribution emanating from the at least one light source than, for instance, a flat reflector canopy of the same dimensions. An arcuate shape may further provide a degree of shaping of the luminous output of the luminaire so as to deliver a more focused luminous flux into a space than, for instance, provided by a luminaire comprising a flat reflector canopy.

The luminaire according to any of the herein embodiments may be a troffer and the reflector canopy may be dimensioned to fit into a ceiling recess.

The at least one light source may comprise a solid state lighting element. As well offering advantages in terms of energy efficiency, robustness and longevity, solid state lighting elements are small and light-weight and thus may contribute to the ease and efficiency with which the luminaire may be stored and transported. The luminaire may also include a driver configured to regulate power supplied to the solid state lighting element. The luminaire may further comprise a cover which covers the elongate support member when the driver is non-isolated. The cover may provide protection against electrical shorts and lessen the risk of a user or installer of the luminaire experiencing electric shocks from physical contact with the driver or printed circuit board.

In accordance with another aspect, there is provided a modular ceiling kit comprising at least one luminaire according to any of the herein embodiments.

### BRIEF DESCRIPTION OF THE DRAWINGS

Embodiments of the invention are described in more detail and by way of non-limiting examples with reference to the accompanying drawings, wherein:

FIG. 1 shows a perspective view of an unfolded luminaire according to an embodiment;

FIG. 2 shows a perspective view of a folded shape of the luminaire shown in FIG. 1;

FIG. 3 shows a magnified perspective view of part of the unfolded luminaire shown in FIG. 1;

FIG. 4 includes the perspective view shown in FIG. 2 together with an inset showing a magnified part of the folded shape;

FIG. 5 shows a perspective view of an unfolded luminaire according to another embodiment;

FIG. 6 shows a perspective view of a folded shape of the luminaire shown in FIG. 5;

FIG. 7 includes the perspective view shown in FIG. 5 together with an inset showing a magnified part of the unfolded luminaire;

FIG. 8 show perspective views of unfolded (left hand pane) and folded (right hand pane) shapes of a luminaire according to an embodiment.

### DETAILED DESCRIPTION OF THE EMBODIMENTS

The invention will be described with reference to the Figures. It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

In embodiments of the present invention, a luminaire comprises an elongate support member which carries at least one light source. The elongate support member extends lengthways between opposing end portions. Spacer elements respectively extend from the opposing end portions and support a reflector canopy which extends over the elongate support member. The at least one light source faces the reflector canopy. The reflector canopy is foldable in a direction normal to the lengthways extension of the elongate support member and/or is foldable in the lengthways direction together with the support member.

The terms ‘elongation direction’ and ‘lengthways direction’ are used interchangeably and refer to a direction parallel to the length of the elongate support member.

The term ‘normal direction(s)’ refers to direction(s) perpendicular to the elongation direction.

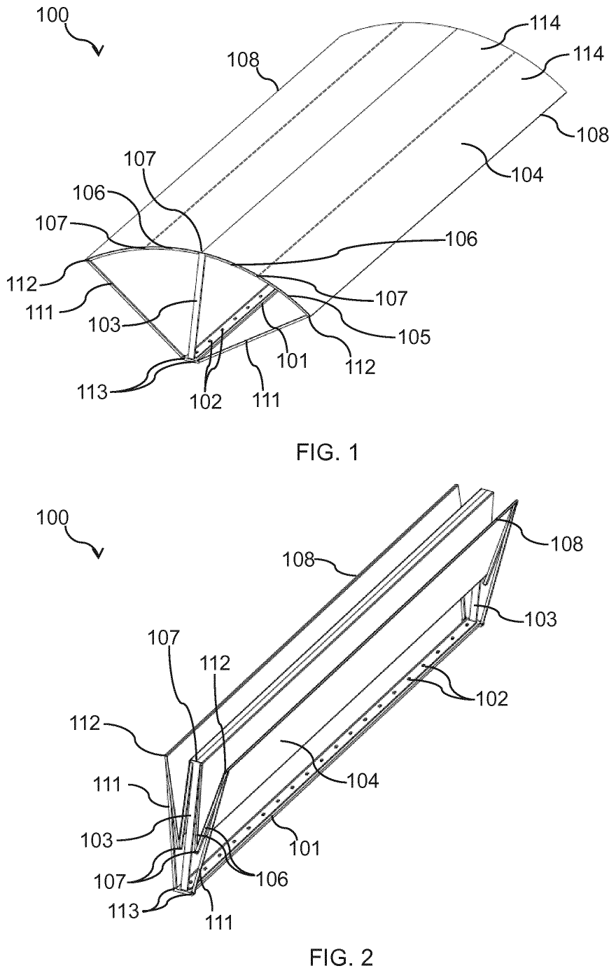

A luminaire 100 according to an embodiment is shown in FIG. 1. The luminaire 100 is shown in an unfolded shape in FIG. 1. A reflector canopy 104 extends over an elongate support member 101 so as to reflect light emanating from light source(s) 102 back towards the elongate support member 101 and beyond in order to provide indirect illumination (e.g. of a space situated underneath the luminaire 100).

According to a first set of embodiments, the reflector canopy 104 may be foldable in the normal direction. In other words, the luminaire 100 may adopt a folded shape, as shown in FIG. 2, wherein the reflector canopy 104 is folded such that its profile in directions normal to the elongation direction are smaller with respect to that of the unfolded shape as depicted in FIG. 1.

Accordingly, the luminaire 100 may adopt a folded shape comprising a smaller form factor than the unfolded shape. Such a folded shape may thus make for greater ease of storage and transportation of the luminaire 100. This is particularly advantageous when a plurality of luminaires 100 is to be stored or transported. Furthermore, the smaller form factor of the folded shape means that less packaging is required for the luminaire 100.

In a non-limiting example, the luminaire 100 may be folded such that the folded shape may be substantially flat. In such an example, the substantially flat shape may, for instance, approximate the shape of a cuboid. Adoption of a substantially flat folded shape facilitates a particularly easy and efficient storage and transportation of the luminaire 100. The substantially flat folded shape may be particularly advantageous for transporting or storing a plurality of such luminaires 100 since they may be efficiently stacked together.

The reflector canopy 104 may be foldable in the normal direction by any suitable means. As shown in FIG. 1, the reflector canopy 104 may comprise a pair of support ribs 105 extending substantially normal to the elongation direction. Each of the support ribs 105 may engage with one of the spacer elements 103. The support ribs 105 may assist to support the reflector canopy 104.

Turning to FIG. 2, the support ribs 105 may comprise a plurality of flexibly coupled members 106 which may facilitate folding of the reflector canopy 104 in the normal direction.

According to this embodiment, the reflector canopy 104 may comprise a plurality of elongate portions 114 extending in the lengthways direction, each elongate portion 114 being at least partially supported by a pair of opposing flexibly coupled members 106.

The couplings 107 between the flexibly coupled members 106 may permit adjacent flexibly coupled members 106 to cooperatively fold and unfold. The respective arrangements of flexibly coupled members 106 and couplings 107 of each of the support ribs 105 may mirror each other, thus enabling the reflector canopy 104 to be folded about an axis or axes parallel to the elongation direction.

The division of the reflector canopy 104 into elongate portions 114 may permit the reflector canopy 104 to comprise either a deformable or a rigid material. In the case of the reflector canopy 104 comprising a rigid material, the elongate portions 114 may not themselves be foldable but the couplings 107 may nonetheless permit folding of the reflector canopy 104. Rigid materials may, for instance, include polymers, wood, fiberboard, metals, metal alloys etc.

In an embodiment, the reflector canopy 104 may comprise a pliable material which may be supported by the support ribs 105. Owing to the pliability of the material, it may deform upon folding/unfolding of the flexibly coupled members 106. Accordingly, the reflector canopy 104 may, for instance, comprise a unitary piece of pliable material.

In an embodiment, the reflector canopy 104 may comprise at least one selected from a polymer film, a paper sheet, and a textile sheet. The polymer film may, for instance, comprise polyethylene terephthalate (PET) although other suitable polymers equally may be used. A degree to which such pliable materials may be deformable may depend, for instance, on their thickness. Any suitable thickness of such pliable materials may be contemplated.

The coupling 107 may comprise any suitable mechanism that may permit folding at least in the normal direction. The coupling 107 may include, by way of non-limiting example, a hinge. Other suitable couplings permitting movement in one or more directions will be immediately apparent to the skilled person, and will not be further described herein for the sake of brevity only.

The coupling 107 may, for instance, comprise a suitable locking mechanism such that the folded and/or unfolded shape of the reflector canopy 104 may be fixed during storage and transportation and/or during use. Locking mechanisms for temporarily restricting or locking the movement of a coupling such as a hinge are well-known per se and will not be further discussed herein for the sake of brevity only.

The reflector canopy 104 may comprise a reflective portion (not shown) which redirects light from the at least one light source 102 back towards the elongate support member 101 and beyond in order to provide the requisite indirect illumination. The reflective portion may, in non-limiting examples, comprise reflective materials such as metal, glass and the like.

In non-limiting examples, the reflector canopy 104 may comprise a non-reflective material (e.g. a polymer, paper, textile, wood, fiberboard etc.) carrying a reflective material, such as in the form of a reflective coating. In embodiments wherein the reflector canopy 104 comprises a pliable material, such as a polymer film, a paper sheet, or a textile sheet, the pliable material may, for example, be coated with a reflective coating. The reflective coating and the quantity applied to the pliable material may be such as to avoid excessive stiffening of the pliable material. Such a reflective coating is not especially limited and may, for instance, comprise a glass, metal, mineral, and the like. Inclusion of a mineral, such as TiO₂, into the reflective coating may assist the reflective portion to provide diffuse reflectance. Reflective materials/coatings are well-known per se and will not be further described herein for the sake of brevity only. In an alternative non-limiting example, the pliable material may be both pliable and reflective (e.g. a polymer film or a metal foil).

The luminaire 100 may, in non-limiting examples, further comprise a louver (not shown) which may assist to reduce glare and thus may improve the quality of the lighting provided by the luminaire 100. The louver may be positioned with respect to the reflector canopy 104 such that light reflected by the reflector canopy 104 may pass through the louver before exiting the luminaire 100. The louver may, for example, be foldable such that it may be folded in the normal direction and/or the elongation direction. The louver may also, for instance, be lockable in an unfolded and/or a folded configuration in order to prevent unwanted folding during operation of the luminaire 100 or unwanted unfolding during storage or transportation of the luminaire 100. Alternatively or additionally, the louver may be detachable from the luminaire 100 and may be secured to the (e.g. unfolded) luminaire 100 by any suitable fixing components, such as clips, screws, etc. The louver may, for example, be secured to the elongate support member 101 or the spacer elements 103.

In an embodiment, the reflector canopy 104 may further comprise a pair of further support ribs 108. Each of the further support ribs 108 may extend between the pair of support ribs 105 along respective edges of the reflector canopy 104 parallel to the elongation direction. Such further support ribs 108 may provide additional support to the reflector canopy 104. Thus the further support ribs 108 may be included in the reflector canopy 104, for instance, in embodiments wherein the reflector canopy 104 comprises a pliable material so as to provide structural support. In alternative non-limiting examples, the further support ribs 108 may be employed in combination with a reflector canopy 104 comprising a rigid material.

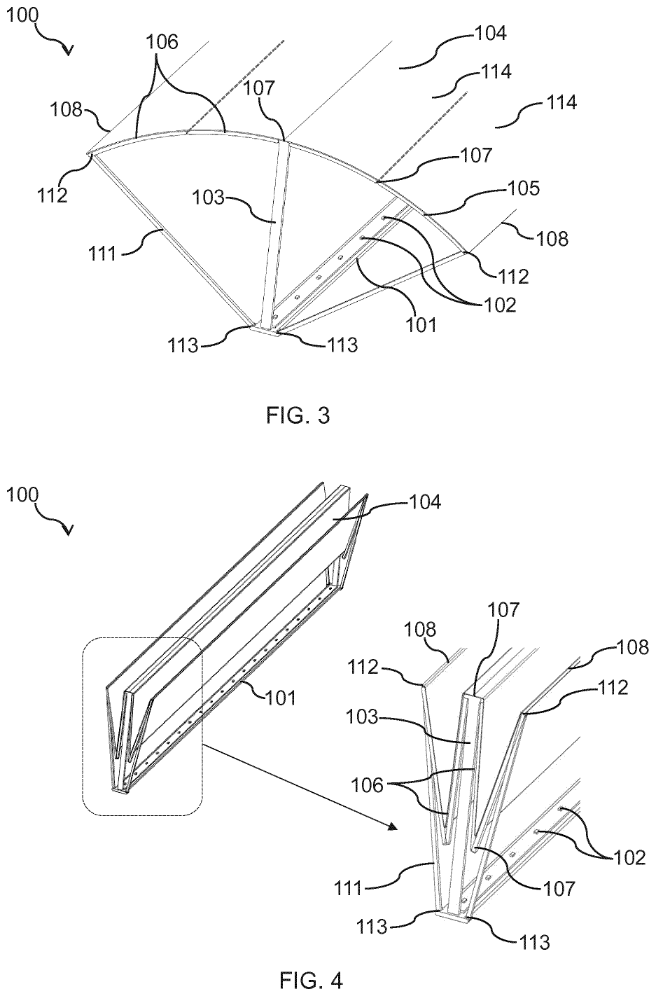

In an embodiment, the reflector canopy 104 (when the luminaire 100 is unfolded as shown in FIGS. 1 and 3) may comprise an arcuate shape and may arch over the elongate support member 101 in the normal direction. In other words, the arcuate shape of the reflector canopy 104 may terminate at edges of the reflector canopy 104 running parallel to the elongation direction. An arcuate shape may improve the luminous efficiency of the reflector canopy 104 by permitting it to collect and redirect a greater angular proportion of the luminous distribution emanating from the at least one light source 102 than, for instance, a flat reflector canopy 104. An arcuate shape may further provide a degree of shaping of the luminous output of the luminaire 100 so as to deliver a more focused luminous flux into a space than, for instance, provided by a luminaire 100 comprising a flat reflector canopy 104.

The arcuate shape may, for instance, be provided by the support ribs 105 comprising an arcuate shape so as to arch over the elongate support member 101 in the normal direction. The reflector canopy 104 may adhere to the arcuate support ribs 105 such that the reflector canopy 104 may adopt the arcuate shape of the support ribs 105. Other shapes for the reflector canopy 104, such as flat or corrugated may also be contemplated.

FIG. 3 shows a magnified perspective view of part of the unfolded luminaire 100 shown in FIG. 1. In an embodiment, the luminaire 100 may comprise at least one pair of opposing support limbs 111. Each of the support limbs 111 may extend from a first connection point 112 located at a corner of the reflector canopy 104 to a second connection point 113 with the elongate support member 101. Alternatively, the first connection point 112 may be located at an edge of the reflector canopy 104 running parallel to the elongation direction.

In embodiments where the reflector canopy 104 may be folded in the direction normal to the elongation direction, the first connection point 112 and second connection point 113 may both comprise pivot points in order to permit this folding. As shown in greater detail in FIG. 4, the pivoting connection points 112 and 113, in combination with the flexibly coupled members 106, may permit the reflector canopy 104 to be folded in the normal direction.

The reflector canopy 104 may be at least partially supported by a pair of spacer elements 103 which may extend from opposing end portions of the elongate support member 101. Whilst the opposing end portions as depicted in FIG. 1 (and the other figures) are located at opposing extremities along the length of the elongate support member 101, this is not intended to be limiting. It is also conceivable that the spacer elements 103 may extend from opposing end portions which are not situated at these respective extremities but, rather, may be sufficiently proximal to the respective extremities in order to least partially support the reflector canopy 104.

As shown in FIG. 1, the spacer elements 103 may respectively engage with the opposing support ribs 105. However, this is also not intended to be limiting. Where, for instance, the reflector canopy 104 does not comprise support ribs, the spacer elements 103 may engage the reflector canopy 104 at lateral edges of the reflector canopy 104 extending in the normal directions. Alternatively, the spacer elements 103 may engage the reflector canopy 104 at points sufficiently proximal to the lateral edges or support ribs 105 (if present) so as to partially support the reflector canopy 104.

The spacer elements 103, support ribs 105, further support ribs 108, and support limbs 111 may be formed of any suitable material, such as a polymer, a metal (e.g. aluminium) or a metal alloy (e.g. steel), which may be capable of providing structural support to the reflector canopy 104.

In embodiments wherein the reflector canopy 104 comprises a pliable material, the support ribs 105 and further support ribs 108 may, for instance, comprise a further rigid material such as a metal (e.g. aluminium), or a metal alloy (e.g. steel). This may provide structural support to the reflector canopy 104. The pliable material may be a light-weight thin film or sheet such that the pliable material may compensate for an increased weight associated with the further rigid material.

The use of a light-weight material for the reflector canopy 104 (e.g. a polymer film, a paper sheet, or a textile sheet) may compensate for the structural elements of the luminaire 100, such as the elongate support member 101, spacer elements 103, support ribs 105, further support ribs 108, and support limbs 111, comprising a heavier-duty material, such as a metal (e.g. aluminium) or a metal alloy (e.g. steel).

The elongate support member 101 may be formed of any suitable material, such as a polymer, a metal (e.g. aluminium), or a metal alloy (e.g. steel). The elongate support member 101 may, for instance, be formed of a metal or metal alloy in order to provide mechanical strength and to assist with heat dissipation during operation of the at least one light source 102. The spacer elements 103 may, for instance, be formed of a metal (e.g. aluminium) or a metal alloy (e.g. steel) in order to assist with heat dissipation during operation of the at least one light source 102.

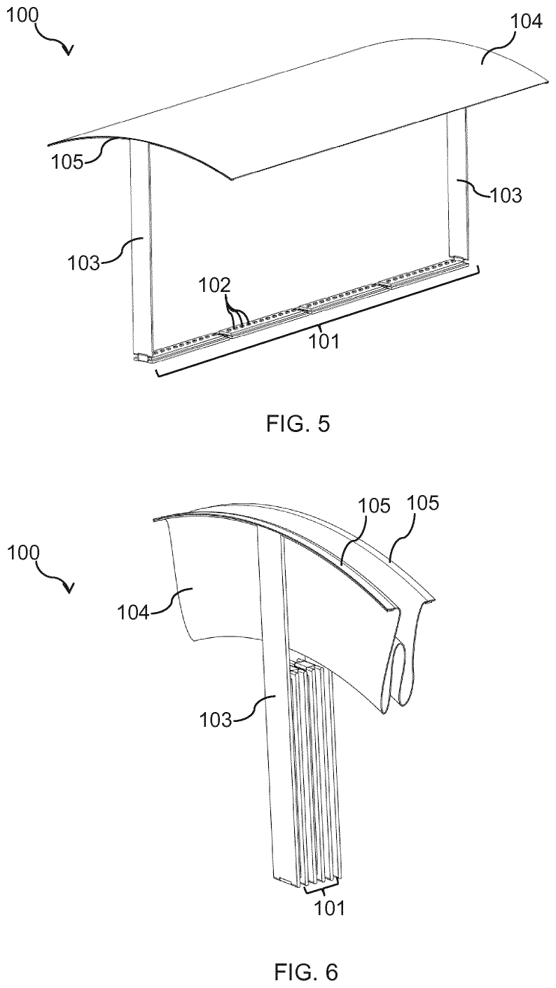

According to a further set of embodiments, the reflector canopy 104 may be foldable in the elongation direction, together with the elongate support member 101. Such a luminaire 100 is depicted in FIG. 5 (unfolded shape) and FIG. 6 (folded shape). In FIG. 6, the reflector canopy 104 is folded such that its extension in the elongation direction (as defined in respect of the unfolded luminaire 100) is decreased with respect to that of the unfolded shape as depicted in FIG. 5. Accordingly, the folded shape of the luminaire 100 may comprise a smaller form factor than the unfolded shape resulting in greater ease and efficiency of storage/transportation of the folded luminaire 100.

The figures show the first set of embodiments (FIGS. 1-4) and the further set of embodiments (FIGS. 5-7) as alternatives. However, this should not be regarded as being limiting. It is further contemplated that the luminaire 100 may be folded in both the elongation/lengthways direction and in direction(s) normal to the elongation direction. It should therefore be noted that the components of the luminaire 100 as described above in respect of the first set of embodiments may also be applicable in the context of the further set of embodiments and vice versa.

The luminaire 100 is shown in an unfolded shape in FIG. 5. A reflector canopy 104 extends over an elongate support member 101 so as to reflect light emanating from light source(s) 102 back towards the elongate support member 101 and beyond in order to provide indirect illumination (e.g. of a space underneath the luminaire 100), as previously described in respect of the luminaire 100 of FIG. 1. In the embodiment shown in FIG. 5, the reflector canopy 104 may comprise support ribs 105 which may engage with the spacer elements 103, as previously described in relation to FIG. 1.

As shown in FIG. 6, the reflector canopy 104 may comprise a pliable material such that it may deform as the elongate support member 101 is folded. In this way, the reflector canopy 104 may be foldable in the elongation direction together with the elongate support member 101. The folded shape of the luminaire 100 may comprise a smaller form factor than the unfolded shape resulting in greater ease and efficiency of storage/transportation of the folded luminaire 100. Furthermore, the smaller form factor may mean that less packaging is required for the luminaire 100.

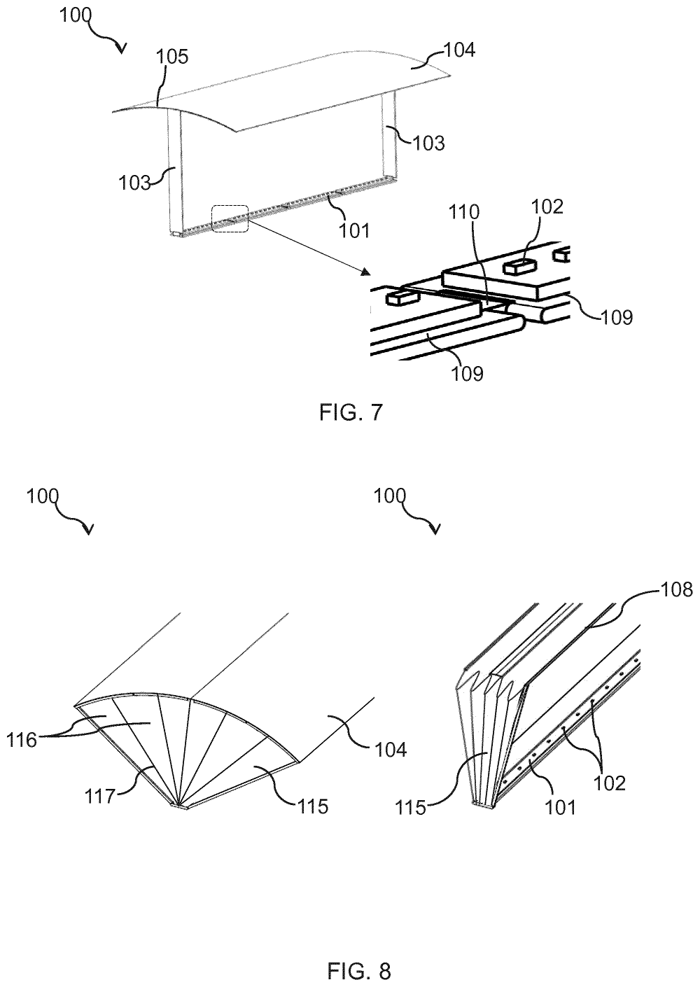

The elongate support member 101 may be foldable in the elongation direction by any suitable means. As depicted in FIGS. 6 and 7, the luminaire 100 may comprise a plurality of flexibly coupled segments 109 to facilitate folding in the elongation direction. As shown in FIGS. 6 and 7, the neighbouring further couplings 110 of the plurality of flexibly coupled segments 109 may be configured to pivot in opposite directions relative to each other such that the segments 109 are stacked upon folding in the elongation direction. Stacking of the flexibly coupled segments 109 in this way may result in spatially efficient folding of the elongate support member 101 in the elongation direction.

Other means of flexibly coupling the elongate support member 101 will be apparent to the skilled person. In an alternative non-limiting example, the elongate support member 101 may be telescopic by virtue of a pair of neighbouring flexibly coupled segments 109 being adapted to be slidable relative to each other in the elongation direction, and one segment 109 of the pair being proportioned such that the other segment 109 may be at least partially contained within it upon adoption of the folded shape of the luminaire 100. Accordingly, such an arrangement will be readily understood by the skilled person to facilitate adjustment of an extension of the elongate support member 101 in the elongation direction.

The further coupling 110 may, for instance, comprise a further suitable locking mechanism such that the elongate support member 101 may be fixed either in a folded state during storage and transportation or an unfolded state during use of the luminaire 100. Locking mechanisms for temporarily restricting the movement of a coupling such as a hinge are well-known per se and will not be further discussed herein for the sake of brevity only.

The reflector canopy 104 of the luminaire 100 according to the further set of embodiments may, for instance, comprise further support ribs running along edges of the reflector canopy 104 parallel to the elongation direction (not shown in FIGS. 5-7). As described in relation to the first set of embodiments, the further support ribs may provide additional support to the reflector canopy 104. However, in order to ensure that the reflector canopy 104 is foldable in the elongation direction, the further support ribs may be foldable or bendable.

The support ribs (not shown in FIGS. 5-7) may, for instance, comprise a material which is capable both of providing a degree of support to the reflector canopy 104 when it is in the unfolded state, and bending so as to facilitate adoption of the folded state (folding in the elongation direction). In an alternative non-limiting example, the further support ribs may comprise a plurality of flexibly coupled portions such that the further support ribs may be foldable in a similar way as described in relation to the elongate support member 101.

In an embodiment, the at least one light source 102 may comprise a solid state lighting element, for example a light emitting diode (LED). The at least one light source 102 or solid state lighting element may, for instance, be mounted directly on the elongate support member 101. This may be achieved by, for instance, adhering the light source 102 or solid state lighting element to the elongate support member using a glue or adhesive strip. In an example, the glue or adhesive strip may be thermally conducting such that dissipation of the heat generated by the light source 102 or solid state lighting element to the elongate support member may be assisted. The elongate support member 101 may be a foldable PCB onto which the one or more light sources 102 are mounted in any suitable manner.

In alternative non-limiting examples, such solid state lighting elements may, for instance, be mounted on a printed circuit board (PCB) which may be fixed to the elongate support member 101. For example, where the elongate support member 101 is foldable, each portion or segment of such a foldable elongate support member 101 may carry a separate PCB. In order to assist heat dissipation, the PCB may, for instance, be fixed to the elongate support member 101 using a thermally conductive glue or adhesive strip(s). PCBs, and means of mounting solid state lighting elements on them, are well-known per se and will not be further described herein for the sake of brevity only.

The solid state lighting element may, for example, be configured to emit light with a particular spectral composition, i.e. colour. In a non-limiting example, a plurality of solid state lighting elements may be employed and at least two of the solid state lighting elements may be adapted to emit light of different colour with respect to each other. The at least two solid state lighting elements may, for instance, be dimmable and/or may be able to produce an output having a configurable spectral composition, e.g. a white light output having a configurable colour temperature, e.g. a colour temperature ranging from about 2,000 to about 8,000 K, e.g. from about 2,500 K to about 6,500 K, and/or a configurable coloured output having a spectral composition having a central spectral component ranging from 400 nm to 700 nm for example. The luminaire 100 may achieve a configurable luminous output in any suitable manner: for example, by each individual solid state lighting element being able to produce such a configurable spectral composition or by a plurality of individually controllable solid state lighting elements producing outputs of different spectral compositions, and positioned such that respective luminous outputs are mixed to form light of a desired spectral composition, e.g. white light. In a non-limiting example, the spectral composition provided by the luminaire 100 comprising different colour-emitting solid state lighting elements may be homogenized (i.e. colour-mixed) by employing a reflector canopy 104 comprising a reflective portion which is at least partially diffusively reflective. More generally, where the light sources 102 include light sources capable of generating different spectral compositions, the light sources may be individually addressable such that a selection of solid state lighting elements may be engaged to produce an output of a desired spectral composition.

The luminaire 100 may further comprise a driver (not shown) configured to regulate power supplied to the solid state lighting element. The driver may be isolated or non-isolated. Drivers for solid state lighting elements are well-known per se and will not be further described herein for the sake of brevity only. In non-limiting examples, the driver may be directly mounted on or housed within the elongate support member 101.

In an embodiment, the luminaire 100 may further comprise a cover which covers the elongate support member 101. Such a cover may be used when, for instance, the driver is non-isolated. The cover may further cover a PCB on which the solid state lighting element(s) may be mounted. Such a cover may comprise any suitable (e.g. certified) insulator material such that the cover may provide protection against electrical shorts and lessen the risk of a user or installer of the luminaire 100 experiencing electric shocks from physical contact with the driver or printed circuit board. Alternatively or additionally, the cover may comprise a suitable flame retardant material. Suitable insulating materials and flame retardant materials are well-known per se and will not be further described herein for the sake of brevity only.

In alternative non-limiting examples, an isolated driver such as an isolated class 2 driver may be used. The isolated driver may obviate the requirement (e.g. a safety requirement) for such a cover. A coverless luminaire 100 may mean that the luminaire 100 is lighter such that it may be more easily and cheaply transported.

In order to assist heat dissipation, the driver may be mounted on the elongate support member 101 using a thermally conductive glue or adhesive strip(s).

In alternative non-limiting examples, the driver may be located elsewhere in the luminaire 100, such as in or on a spacer element 103. Alternatively the driver may be positioned separately from the luminaire 100. In either case, electrical wiring running between the driver and the elongate support member 101 may connect the driver to the solid state lighting elements.

In non-limiting examples, the lighting provided by the luminaire 100 may be controlled by a controller. Such control systems employing a controller to control a luminaire or a plurality of luminaires are well-known per se. When a plurality of luminaires 100 are employed, the controller may be configured to provide a control signal for controlling each individual luminaire 100 or alternatively may be configured to provide a single control signal for controlling several luminaires 100. The controller may, for example, be operated by a user and/or may provide automatic control over the luminaire(s) 100. Such automatic control may, for example, be based on a preset lighting routine or sensory input. For example, the controller may be adapted to adjust at least one of a dimming level and the spectral composition of the luminous output of the luminaire 100, in response to a sensor signal. Alternatively or additionally, the controller may increase or decrease the number of light sources 102 being switched on in response to such a sensor signal. Other suitable sensor-controlled adjustments to the luminous output of the luminaire 100 will be immediately apparent to the skilled person. The controller may be responsive to a user-generated control signal, e.g. provided via a wall-mounted switch or via a remote controller, which may be a dedicated remote controller or an electronic device configured by an app or the like to provide such remote control functionality. To this end, the luminaire 100 may comprise a wireless communication module through which the controller may receive such control instructions using any suitable wireless communication protocol.

In an embodiment the luminaire 100 may be incorporated in a modular ceiling. Such a ceiling typically comprises a plurality of panels that can be suspended in a frame. The frame may be a modular frame, e.g. formed from a plurality of interconnected frame elements, e.g. strips. In such a modular ceiling, the luminaires 100 may form or replace at least some of the panels in order to provide ceiling lighting. Luminaires 100 in the form of troffers are particularly preferred in such modular ceilings.

The luminaire 100 may be a troffer which may be employed as a panel in a modular ceiling. In such an embodiment, the reflector canopy 104 may be dimensioned to fit into a ceiling recess. Accordingly, the width and length dimensions of the reflector canopy 104 may, for instance, substantially match the area of a panel of the modular ceiling. The area of such panels tends to be standardized (e.g. 2 feet by 2 feet or 2 feet by 4 feet). Of course, other dimensions for the ceiling panel or recess and thus the reflector canopy 104 are conceivable. The luminaire 100 may, for example, be recessed into a plenum area above the modular ceiling. Accordingly, the depth of the luminaire 100 may mean that it may fit into the plenum area above the modular ceiling such that, for instance, it does not protrude from the modular ceiling into the room below.

The luminaire 100 may be mounted in the modular ceiling by employing a hook, lip or other means of engaging with an element of the ceiling recess. In a non-limiting example, edges of the reflector canopy 104 running parallel to the elongation direction may respectively engage with, and be at least partially supported by, edge portions of opposing frame elements which delineate a panel. When, for instance, the reflector canopy 104 comprises further support ribs 108, these may rest on these edge portions.

In a scenario where an arcuate reflector 104 is employed, the luminaire 100 may, for example, further comprise blocking panels 115 as shown in FIG. 8. These blocking panels 115 may be mounted on opposing sides of the reflector canopy 104 extending in the normal direction, and may prevent users from observing the plenum area above the modular ceiling through a gap between the modular frame and the highest point of the arc shape.

As shown in FIG. 8, the blocking panels 115 may be foldable in order to accommodate folding or unfolding of the luminaire 100. This may be achieved by, for example, the blocking panels 115 comprising pliable portions 116 held between spines 117 thus permitting the blocking panel 115 to be folded (right hand pane of FIG. 8) and unfolded (left hand pane of FIG. 8) like a fan. In the non-limiting example shown in FIG. 8, the spines 117 may be flexibly joined by any suitable pivot, for instance located at the elongate support member 101 or on a spacer element 103, such that the blocking panel 115 may be fanned out or folded by pivoting of the spines 117 relative to each other about the pivoting axis.

Whilst the pivot is depicted as being positioned at the elongate support member 101 in FIG. 8, in other non-limiting examples the pivot may be positioned on the spacer element 103 at a set distance from the highest point of the arc shape so as to avoid the unfolded blocking panel 115 extending beneath the modular frame (i.e. into the room below).

The pliable portions 116 may comprise any suitable deformable material such as a polymer film, a paper sheet, or a textile sheet. The blocking panels 115 may, for instance, be reflective. Accordingly, the pliable portions 116 may be coated at least on a surface facing the inside of the luminaire 100 with a reflective coating as described above in relation to the reflector canopy 104. The spines 117 may be sufficiently rigid to support the pliable portions 116 and may be made from any suitable material such as a polymer, metal or metal alloy. The foldable blocking panels 115 may, for example, be also secured to the reflector canopy 104 by any suitable fixing components such as clips, screws, etc.

Alternatively or additionally, the blocking panels 115 may be detachable from the luminaire 100 and may be secured to the (e.g. unfolded) luminaire 100 by any suitable fixing components, such as clips, screws, etc.

In an alternative non-limiting example, the luminaire 100 may be suspended from a ceiling as a pendant luminaire.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A luminaire comprising:
an elongate support member extending in an elongation direction between opposing end portions, and carrying at least one light source;
a pair of spacer elements extending from said opposing end portions; and
a reflector canopy extending over the support member and being at least partially supported by the pair of spacer elements, wherein the reflector canopy comprises a pair of support ribs extending normally to said elongation direction, each of said ribs engaging with one of said spacer elements, wherein:
the reflector canopy is foldable in a direction normal to said elongation direction, and each of the support ribs comprise a plurality of flexibly coupled members for facilitating folding of the reflector canopy in said normal direction;
and/or
the reflector canopy is foldable in the elongation direction together with the support member, and the elongate support member further comprises a plurality of flexibly coupled segments (109) to facilitate folding in said elongation direction;
and wherein, said at least one light source faces the reflector canopy when the luminaire is in an unfolded status.

2. The luminaire of claim 1, wherein neighbouring couplings of the plurality of flexibly coupled members are configured to pivot in opposite directions relative to each other such that the flexibly coupled members are stacked upon folding of the reflector canopy in said normal direction.

3. The luminaire of claim 1, wherein the reflector canopy further comprises a pair of further support ribs, each further support rib extending between the pair of support ribs along an edge of the reflector canopy parallel to said elongation direction.

4. The luminaire of claim 1, wherein the luminaire further comprises at least one pair of opposing support limbs, each of said support limbs extending from a first connection point located at a corner or an edge of the reflector canopy parallel to said elongation direction to a second connection point with the elongate support member; and wherein the first and second connection points comprise pivot points when the reflector canopy is foldable in said normal direction.

5. The luminaire of claim 1, wherein neighbouring further couplings of the plurality of flexibly coupled segments are configured to pivot in opposite directions relative to each other such that the segments are stacked upon folding in said elongation direction.

6. The luminaire of claim 1, wherein the reflector canopy comprises a pliable material.

7. The luminaire of claim 1, wherein the reflector canopy comprises at least one selected from a polymer film, a paper sheet, and a textile sheet.

8. The luminaire of claim 1, wherein the reflector canopy comprises an arcuate shape and arches over the elongate support member in said normal direction.

9. The luminaire of claim 1, wherein the luminaire is a troffer and the reflector canopy is dimensioned to fit into a ceiling recess.

10. The luminaire of claim 1, wherein the at least one light source comprises a solid state lighting element.

11. The luminaire of claim 10, wherein the elongate support member includes a driver configured to regulate power supplied to the solid state lighting element; and wherein the luminaire further comprises a cover which covers the elongate support member when said driver is non-isolated.

12. A modular ceiling kit comprising at least one luminaire according to claim 1.
